(19) United States
(12) Patent Application Publication
(10) Pub. No.: US 2008/0207831 A1
(43) Pub. Date: Aug. 28, 2008

(54) Composition comprising polyvinyl chloride and halogenated polyethylene or core-shell resin

(76) Inventor: Stewart Carl Feinberg, Exton, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/712,454

(22) Filed: Feb. 28, 2007

(51) Int. Cl. C08L 51/04

(52) U.S. Cl. 525/71

(57) ABSTRACT

Disclosed is a composition including, or produced from, PVC, filler, and an impact strength-retaining amount of a modifier wherein the modifier includes is or a halogenated polyolefin, a core-shell resin, or combinations thereof. Also disclosed is a process which comprises combining the modifier to a blend that comprises or is produced by combining rigid PVC and one or more fillers. Further disclosed are articles comprising or produced from the composition.

### FIELD OF THE INVENTION

The invention relates to a composition comprising polyvinyl chloride (PVC) and a halogenated polyethylene or a core-shell resin and to a product therewith.

### BACKGROUND OF THE INVENTION

Almost all PVC that is used in extruded profiles (windows, siding, and doors) is impact-modified to some extent. Recently there has been an increased interest in composition of wood and PVC, particularly for use in home siding applications. Such composites are highly desirable because they resemble traditional wood siding. Moreover, such composition raises the sag temperature of PVC and thus permits the use of dark colors in the composite siding. See, e.g., U.S. Pat. Nos. 6,011,091, 6,103,791, and 6,066,680, and US Patent Application 2003/0229160.

To broaden markets and opportunities for PVC, various reinforcing fillers such as fiberglass or minerals are compounded into rigid PVC formulations in order to increase the stiffness (flexural modulus) of the polymer. Unfortunately, other physical properties are degraded by the addition of the reinforcing filler, usually in direct proportion to the amount of such filler that is added. Consequently, end users of the rigid PVC formulations are constantly searching for modifiers that prevent or minimize the reduction of such desirable properties. It is also desirable to prevent or minimize the loss of impact properties of the PVC, to improve or reduce the molten viscosity, or to minimize the loss in stiffness of PVC (as compared to the unmodified PVC).

### SUMMARY OF THE INVENTION

A composition comprises, consists essentially of, or consists of, polyvinyl chloride, filler, and an impact-strength-retaining amount of a modifier including a halogenated polyolefin, a core-shell resin, or combinations thereof.

A process for reducing molten viscosity, or to minimize the loss in stiffness, of PVC (as compared to the unmodified PVC) comprising combining PVC and a filler with a modifier, which can be the same as that disclosed above.

### DETAILED DESCRIPTION OF THE INVENTION

Any filler or additive that may improve the stiffness of PVC may be used. Examples of such fillers include, but are not limited to, one or more glass fibers, hollow glass microspheres, inorganic compounds, such as minerals and salts including CaCO₃, silica, silicates such as calcium silicate or metasilicate, clay such as bentonite, mica, talc, alumina trihydrate, magnesium hydroxide, metal oxides, or combinations of two or more thereof. The filler can be present in an amount that is sufficient to improve the stiffness of PVC and can be about 0.001 to about 50, preferably, about 1 to about 25%, or more preferably, from about 2 to about 15%, by weight of the resulting blend.

A halogenated polyolefin can include halogenated polyethylene, halogenated polypropylene such as polytetrafluoroethylene, fluoropolyethylene, chloropolyethylene, bromopolyethylene, fluoropolypropylene, chloropolypropylene, bromopolypropylene, or combinations of two or more thereof. Such halogenated polyolefins are readily available and can be produced by halogenation of polyolefin or other means. For example, chloropolyethylene may be produced by chlorination of polyethylene in aqueous or aqueous/hydrochloric acid-suspension with chlorine gas. See, e.g., U.S. Pat. No. 4,440,925, disclosure of which is incorporated herein by reference.

A core-shell polymer has a solvent insoluble core, and a solvent soluble shell, chemically attached to the core. The shell may be in the form of macromonomer chains or arms attached to it. The core-shell polymer may be a polymer particle dispersed in an organic media with average particle size of the core ranging from 0.1 to 1.0μ, 0.15 to 0.6μ, or 0.15 to 0.6μ. The core-shell polymer can include in the range of from about 10 to about 90 or 50% to 80% by weight based on the weight of the dispersed polymer, of a core formed from high molecular weight polymer having a weight average molecular weight of about 25,000 to about 500,000, about 35,000 to about 200,000, or about 50,000 to about 150,000. The arms make up about 10% to 90% or 20% to 50% by weight based on the weight of the core-shell polymer. The arms can be formed from a low molecular weight polymer having weight average molecular weight in the range of from about 1,000 to 50,000 or 3,000 to 30,000. The core of the dispersed core-shell polymer can comprise one or more polymerized acrylic monomers including hydroxy alkyl(meth)acrylate or alkyl(meth)acrylate (alkyl(meth)acrylate includes alkyl acrylate, alkyl methacrylate, or both) where the alkyl can contain 1 to 18 or 1 to 12 carbon atoms, styrene, cycloalkyl(meth)acrylate where the cycloalkyl contains 3 to 18 or 3 to 12 carbon atoms, ethylenically unsaturated mono-carboxylic acids (e.g., (meth)acrylic acid including acrylic acid, methacrylic acid, or both), silane-containing monomer, epoxy-containing monomer (e.g., glycidyl(meth)acrylate), or combinations of two or more thereof. Other optional monomers can include amine-containing monomer, or (meth)acrylonitrile, or combinations thereof. Optionally, the core may be crosslinked through the use of diacrylates or dimethacrylates, (e.g., allyl methacrylate) or through post reaction of hydroxyl moieties with polyfunctional isocyanates or carboxylic moieties with epoxy moieties. Core-shell polymer can be made by any means known to one skilled in the art such as that disclosed in U.S. Pat. No. 5,859,136, incorporated herein by reference.

The composition can comprises impact strength-retaining amount of the modifier, which can be from about 0.1 to about 20, about 0.5 to about 15, or about 1 to about 10 weight % of the weight of the composition.

The composition can also include an ethylene copolymer comprising repeat units derived from ethylene and alky (meth)acrylate, vinyl acetate, (meth)acrylic acid (completely or partially neutralized (meth)acrylic acid), or combinations of two or more thereof. An ethylene copolymer may comprise up to 35 wt % of an additional comonomer such as carbon monoxide, sulfur dioxide, acrylonitrile, maleic anhydride, dimethyl maleate, diethyl maleate, dibutyl maleate, dimethyl fumarate, diethyl fumarate, dibutyl fumarate, dimenthyl fumarate, maleic acid, maleic acid monoesters, itaconic acid, fumaric acid, fumaric acid monoester, a salt of these acids, glycidyl acrylate, glycidyl methacrylate, and glycidyl vinyl ether, where the ester can be one or more C₁ to C₄ alcohols (e.g., methyl, ethyl, n-propyl, isopropyl and n-butyl alcohols), combinations of two or more thereof.

The ethylene copolymers are well known to one skilled in the art and the description of which is omitted herein for the interest of brevity. Examples of ethylene alky (meth)acrylate copolymers include ethylene acrylate, ethylene methyl acrylate, ethylene ethyl acrylate, ethylene butyl acrylate, ethylene n-butyl acrylate carbon monoxide (ENBACO), ethylene glycidyl methacrylate (EBAGMA), or combinations of two or more thereof such as Elvaloy® commercially available from E. I. du Pont de Nemours and Company, Wilmington, Del. (DuPont). A mixture of two or more different ethylene alkyl (meth)acrylate copolymers can be used.

Example of ethylene vinyl acetate (EVA) copolymer also includes ethylene/vinyl acetate/carbon monoxide (EVACO). EVA may be modified by methods well known in the art, including modification with an unsaturated carboxylic acid or its derivatives, such as maleic anhydride or maleic acid. Examples of commercially available EVA includes Elvax® from DuPont.

Examples of acid copolymers include ethylene/(meth)acrylic acid copolymers, ethylene/(meth)acrylic acid/n-butyl (meth)acrylate copolymers, ethylene/(meth)acrylic acid/iso-butyl (meth)acrylate copolymers, ethylene/(meth)acrylic acid/tert-butyl (meth)acrylate copolymers, ethylene/(meth)acrylic acid/methyl (meth)acrylate copolymers, ethylene/(meth)acrylic acid/ethyl (meth)acrylate copolymers, ethylene/maleic acid and ethylene/maleic acid monoester copolymers, ethylene/maleic acid monoester/n-butyl (meth)acrylate copolymers, ethylene/maleic acid monoester/methyl (meth)acrylate copolymers, ethylene/maleic acid monoester/ethyl (meth)acrylate copolymers, or combinations of two or more thereof such as Nucrel® commercially available from DuPont.

Ionomers can be prepared from the acid copolymer by treatment with a basic compound capable of neutralizing the acid moieties of the copolymer to any level from about 0.1 to about 99 or 90%, about 15 to about 80%, or about 40 to about 75% with an alkaline earth metal ion, an alkali metal ion, or a transition metal ion. Examples of commercially available ionomers include Surlyn® from DuPont.

Processes for producing acid copolymer and ionomers are well known to one skilled in the art, the description of which is omitted herein for the interest of brevity.

An acid anhydride- or acid monoester-modified polyolefin can be polyethylene (PE) or polypropylene (PP) grafted with an acid anhydride. Polyolefin can include any polymer comprising repeat units derived from an olefin and includes polyethylene, polypropylene, polybutylene, polyisobutylene, and a copolymer of any of these polyolefins. Such copolymer can include comonomers including butene, hexene, octene, decene, dodecene, or combinations of two or more thereof.

Acid anhydride or monoester can include maleic anhydride, itaconic anhydride, fumaric anhydride, maleic acid monoesters, itaconic monoesters, fumaric acid monoester, a salt thereof where the ester can be one or more C₁ to C₄ alcohols (e.g., methyl, ethyl, n-propyl, isopropyl and n-butyl alcohols), combinations of two or more thereof.

Acid anhydride- or acid monoester-modified polyolefin can be produced by any means known to one skilled in the art. For example, grafts can be produced by melt extrusion of the polyolefin in the presence of both a radical initiator and acid anhydride or its monoester, in a twin-screw extruder. The polymeric backbone on which an acid anhydride (e.g., maleic anhydride) functionality is grafted can be either any polyolefins disclosed above such as PE, PP, low density polyethylene (LDPE), linear low density PE (LLDPE), very low density PE (VLDPE), metallocene-catalyzed linear low-density PE (mLLDPE), metallocene-catalyzed very low-density PE (mVLDPE), or combinations of two or more thereof. Example of such polyolefin can be, for example, a copolymer derived from ethylene, carbon monoxide, and butyl acrylate and grafted with maleic anhydride such as FUSABOND® A MG-423D (ethylene/alkyl acrylate/CO copolymer that has been modified with 1% maleic anhydride graft), available from DuPont. Acid anhydride or acid anhydride monoester can be present in the grated polymer, based on the concentration of acid anhydride or acid anhydride monoester, ≧about 0.1, ≧about 1, ≧about 3, ≧about 4, or even ≧about 5 wt %, of the polymer being grafted.

The compositions can additionally comprise, about 0.001 to about 20 weight % of the composition, one or more additives including plasticizers, stabilizers including viscosity stabilizers and hydrolytic stabilizers, antioxidants, ultraviolet ray absorbers, anti-static agents, dyes, pigments or other coloring agents, inorganic fillers, fire-retardants, lubricants, reinforcing agents such as glass fiber and flakes, foaming or blowing agents, processing aids, antiblock agents, release agents, fusion aid, process aid, calcium carbonate, calcium stearate, titanium oxide, stearic acid, paraffin wax, lubricants, pigments, or combinations of one or more thereof. Optional additives, when used, can be present in various quantities so long as they are not used in an amount that detracts from the basic and novel characteristics of the composition.

Composition can be produced by any methods known to one skilled in the art such as standard mixing practices, as generally known in the art. This can be accomplished in a one-step or a two-step process. In the one-step process, all ingredients can be dry- or melt-compounded using a mixer such as Banbury mixer or twin screw or Buss kneader extruders. In the two-step process, the PVC dry blend can be first prepared in a high intensity mixer such as a Welex mixer. In the second step, the Welex blend is melt-blended with additives such as reinforcing fillers and the modifiers in a melt compounding apparatus such as a Buss Kneader or a twin screw extruder.

The composition can be formed into shaped articles using methods such as injection molding, compression molding, overmolding, or extrusion. Optionally, formed articles can be further processed. For example, pellets, slugs, rods, ropes, sheets and molded articles of the present invention may be prepared and used for feedstock for subsequent operations, such as thermoforming operations, in which the article is subjected to heat, pressure and/or other mechanical forces to produce shaped articles. Compression molding is an example of further processing.

The compositions can be cut, injection molded, compression molded, overmolded, laminated, extruded, milled or the like to provide the desired shape and size to produce commercially usable products. The resultant product may have an appearance similar to wood and may be sawed, sanded, shaped, turned, fastened and/or finished in the same manner as natural wood. It is resistant to rot and decay as well as termite attack and may be used as a replacement for natural wood, for example, as decorative moldings inside or outside of a house, railroad ties, picture frames, furniture, porch decks, railings, window moldings, window components, door components, roofing systems, sidings, or other types of structural members.

The following examples are presented to merely demonstrate and illustrate of the invention.

### EXAMPLES

### Raw Materials

The raw starting materials, their characterization and respect commercial source are summarized as follows.

### PVC: Oxy 216, K-=65 (Oxyvinyls); Vista 5305, K=58 (Vista Chemical Co.).

### Chloropolyethylene: Tyrin 3615 (Dow Chemical; Midland, Mich.).

Acrylic core-shell polymer: Paraloid KM334 (Rohm and Haas, Philadelphia, Pa.)
Stabilizers: Mark 1900, methyl tin heat stabilizer (Crompton Corp.); and Irganox 1076, phenolic antioxidant (Ciba Specialty Chemical Co.).
Fusion Aid/Process Aid/Lubricant: Paraloid K120 (Rohm and Haas); calcium stearate; stearic acid; paraffin wax; and Rheolub 165 (Rohm and Haas).
Fillers and Reinforcing Agents: Nyglos 8 and 4W (two grades of calcium metasilicate also known as wollastonite) from Nyco Mineral Co.

### Welex Mixer

The following ingredients were combined in the Welex mixer: PVC powder, stabilizers, fusion aid, process aid, paraffin wax, lubricants, pigments. PVC was added to the Welex high intensity mixer and mixed under high shear over the course for about 30 minutes until the temperature reached approximately 80° C. At this point any liquids in the formulation were added and mixing continued. After several minutes, with the temperature at approximately 90° C., the rest of the ingredients were added. After approximately 5 more minutes, the machine was stopped and the contents were discharged.

### Extrusion Compounding

A Banbury or commercial thermoplastic extruder, such as a twin-screw extruder (Buss Co-kneader) was used to achieve complete admixing of the components and to give a homogenous dispersion of the components. Typical conditions for the Buss Co-kneader were: Zone 1: 110° C.; Zone 2: 180° C.; Zone 3: 180° C.; Zone 4: 180° C.; Crosshead extruder: 180° C.; Die: 180° C.; Crosshead RPM: 50; Buss RPM: 350; Feed rate: 10 to 20 pounds per hour; and Die: one hole, 1/16″ diameter.

### Test Samples

Test pieces bars for flexural modulus, tensile properties, and disks (3 inch by ⅛ inch) for physical testing were molded using a single screw injection molding machine using typically the following temperature profile and conditions: Rear: 170° C.; Center: 180° C.; Front: 180° C.; Nozzle: 170° C.; Mold: 25° C.; Ram Speed: Fast; Screw Speed: 50 rpm; Injection Time: 10 seconds; Hold Time: 15 seconds; and Back Pressure: 50 psig.

Tensile properties were determined according to ASTM D638 using 5 inch by ½ inch by ⅛ inch injection molded bars. The measurements were made on an Instron operated at a crosshead speed of 2 inch/minute. Flexural modulus was measured on 5 inch by ½ inch by ⅛ inch rectangular bars using a 2 inch span, according to ASTM D790. Notched Izod impact was determined according to ASTM D256 using the central portion of the D638 tensile bars having a 0.1 inch notch machined into the side of the bar. Determination of the Dynatup instrumented impact according to ASTM D3763 was performed in the vertical mode on 3 inch by ⅛ inch disks at Tup Size of ½ inch and drop speed of 5 mph (i.e., 10 inch drop in height with 98.2 lb load). The results are shown in the following tables.

Heat deflection temperature was determined according to ASTM D648 using 5 inch by ½ inch by ⅛ inch bars and a load of 1.82 MPa (264 psi).

The compositions of the samples were Table 1 (sample 1, Control—PVC based on Oxyvinyls 216; sample 2, PVC based on Oxyvinyl 216+12 phr Nyglos 8; sample 3, sample 2+7.5 phr TYRIN 3615; and sample 4, sample 2+7.5 phr Paraloid KM334); Table 2 (sample 5, Control—base PVC; sample 6, Control PVC+10 phr Nyglos; sample 7, PVC+10 phr Nyglos+5 phr Tyrin; and sample 8, PVC+10 phr Nyglos+5 phr Paraloid KM334); and Table 3 (sample 9; Control PVC+10 phr Nyglos 8; and sample 10, PVC+5 phr Tyrin+10 phr Nyglos 8).

The numbers shown for individual ingredients in the table were parts per hundred (phr) of PVC.

TABLE 1

| | Example Number | | | |
|---|---|---|---|---|
| | 1 | 2 | 3 | 4 |
| Tyrin 3615 | | | 7.5 | |
| Paraloid KM 334 | | | | 7.5 |
| NYGLOS 8 - In Feed | | 12 | 12 | 12 |
| PVC - Oxyvinyls 216 (K = 62) | 100 | 100 | 100 | 100 |
| PVC - VISTA 5305 (K = 58) | — | — | — | — |
| Mark 1900 | 2.0 | 2.0 | 2.0 | 2.0 |
| Paraloid K120 | 1.0 | 1.0 | 1.0 | 1.0 |
| Rheolube 165 Parafin | 1.0 | 1.0 | 1.0 | 1.0 |
| Calcium Stearate | 1.5 | 1.5 | 1.5 | 1.5 |
| Irganox 1076 | 0.2 | 0.2 | 0.2 | 0.2 |
| Stearic Acid | 0.5 | 0.5 | 0.5 | 0.5 |
| Flex Modulus (psi) | 369,200 | 498,700 | 430,800 | 440,400 |
| Standard Deviation | 41,900 | 31,300 | 32,700 | 45,600 |

Notched Izod Impact @ Room Temperature (about 25° C.) (D638 Tensile Bar)

| | | | | |
|---|---|---|---|---|
| Impact (ft-lb/in) | 0.96 | 1.40 | 1.72 | 2.04 |
| Standard Deviation | 0.27 | 0.28 | 0.70 | 0.32 |
| Failure Mode | Brittle | Brittle | Brittle-Ductile | Brittle-Ductile |

Dynatup Instrumented Impact @ Room Temperature

| | | | | |
|---|---|---|---|---|
| Deflect @ Failure (mm) | 3.22 | 3.67 | 3.97 | 4.41 |
| Standard Deviation | 1.16 | 0.40 | 1.07 | 1.47 |
| Total Energy (J) | 2.36 | 4.55 | 4.81 | 6.76 |
| Standard Deviation | 1.13 | 2.16 | 1.64 | 2.94 |
| Failure Type | Brittle | Brittle | Brittle | Brittle |

Capillary Rheology @ 190° C.

| | | | | |
|---|---|---|---|---|
| 10.0 | 14220 | 15514 | 21639 | 24577 |
| 50.1 | 4693 | 5270 | 5754 | 6640 |
| 100.2 | 3176 | 3383 | 3197 | 4051 |
| 501.2 | 1174 | 1181 | 1092 | 1294 |
| 1002.3 | 713 | 726 | 620 | 747 |
| 2004.6 | 386 | 396 | 340 | 402 |
| 3006.9 | 267 | 274 | 240 | 272 |
| 4009.1 | 202 | 200 | 185 | 202 |
| 5011.4 | 163 | | 149 | |

TABLE 2

| | Example Number | | | |
|---|---|---|---|---|
| | 5 | 6 | 7 | 8 |
| Tyrin 3615 | | | 5.0 | |
| Paraloid Km 334 | | | | 5.0 |
| NYGLOS 8 - In Feed | | 10 | 10 | 10 |
| PVC - Oxyvinyls 216 (K = 62) | 100 | | | |
| PVC - VISTA 5305 (K = 58) | | 100 | 100 | 100 |
| Mark 1900 | 2.0 | 2.0 | 2.0 | 2.0 |
| Paraloid K120 | 1.0 | 1.0 | 1.0 | 1.0 |
| Rheolube 165 Parafin | 1.0 | 1.0 | 1.0 | 1.0 |
| Calcium Stearate | 1.5 | 1.5 | 1.5 | 1.5 |
| Irganox 1076 | 0.2 | 0.2 | 0.2 | 0.2 |
| Stearic Acid | 0.5 | 0.5 | 0.5 | 0.5 |
| FLEX MODULUS (psi) | 333,000 | 338,000 | 317,000 | 315,000 |
| Standard Deviation | 13,000 | 21,000 | 26,000 | 15,000 |

Tensile Properties @ Room Temperature (D638)

| | | | | |
|---|---|---|---|---|
| Young's Modulus (psi) | 452,000 | 469,000 | 444,000 | 430,000 |
| Tensile @ Yield (psi) | 7,500 | 7,500 | 7,000 | 6,900 |
| Elong. @ Yield (%) | 3% | 3% | 3% | 3% |
| Peak Tensile (psi) | 7,500 | 7,500 | 7,000 | 6,900 |
| Elong @ Peak Tensile (%) | 3% | 3% | 3% | 3% |
| Tensile @ Brk (psi) | 5,700 | 5,900 | 5,500 | 5,600 |
| Elong. @ Brk (psi) | 49% | 74% | 67% | 113% |

Notched Izod Impact @ Room Temperature (D638 Tensile Bar)

| | | | | |
|---|---|---|---|---|
| Impact (ft-lb/in) | 1.78 | 1.84 | 1.70 | 1.84 |
| Standard Deviation | 0.86 | 0.91 | 0.64 | 0.54 |
| Failure Mode | Brittle | Brittle | Brittle | Brittle |

Notched Izod Impact @ 0° C. (D638 Tensile Bar)

| | | | | |
|---|---|---|---|---|
| Impact (ft-lb/in) | 0.49 | 2.05 | 3.96 | 2.56 |
| Standard Deviation | 0.11 | 1.85 | 0.49 | 1.65 |
| Failure Mode | Brittle | Brittle | Brittle | Brittle |

Dynatup Instrumented Impact @ Room Temperature

| | | | | |
|---|---|---|---|---|
| Deflect @ Failure (mm) | 13.7 | 5.9 | 11.1 | 15.1 |
| Standard Deviation | 0.3 | 5.3 | 5.3 | 0.3 |
| Total Energy (J) | 57.3 | 18.4 | 41.5 | 63.0 |
| Standard Deviation | 3.1 | 25.7 | 27.2 | 0.7 |
| Failure Type | Ductile | Brittle | Ductile | Ductile |

Dynatup Instrumented Impact @ 0° C.

| | | | | |
|---|---|---|---|---|
| Deflect @ Failure (mm) | 3.4 | 2.8 | 3.7 | 7.8 |
| Standard Deviation | 1.2 | 0.6 | 0.8 | 5.6 |
| Total Energy (J) | 2.9 | 2.8 | 5.7 | 29.4 |
| Standard Deviation | 0.8 | 0.9 | 1.4 | 34.1 |
| Failure Type | Brittle | Brittle | Brittle | Brittle-Ductile |
| HDT @ 264 psi (° C.) (2 samples) | 62.7 | 62.7 | 62.8 | 62.9 |

Capillary Rheology @ 190° C.

| | | | | |
|---|---|---|---|---|
| 10.0 | 9153 | 9323 | 11770 | 11308 |
| 50.1 | 3297 | 3281 | 4085 | 4201 |
| 100.2 | 2055 | 2298 | 2638 | 2793 |
| 501.2 | 808 | 846 | 958 | 1021 |
| 1002.3 | 510 | 520 | 579 | 626 |
| 2004.6 | 306 | 308 | 324 | 346 |
| 3006.9 | 220 | 224 | 230 | 241 |
| 4009.1 | 174 | 174 | 178 | 185 |
| 5011.4 | 142 | 141 | 146 | 150 |

TABLE 3

Example Number

| | 9 | 10 |
|---|---|---|
| Tyrin 3615 | | 5.0 |
| Paraloid Km 334 | | |
| NYGLOS 8 - In Feed | 10 | 10 |
| PVC - Oxyvinyls 216 (K = 62) | | |
| PVC - VISTA 5305 (K = 58) | 100 | 100 |
| TM 181 or Mark 1900 | 2.0 | 2.0 |
| Paraloid K120 | 1.0 | 1.0 |
| Rheolube 165 Parafin | 1.0 | 1.0 |
| Calcium Stearate | 1.5 | 1.5 |
| Irganox 1076 | 0.2 | 0.2 |
| Stearic Acid | 0.5 | 0.5 |
| Flex Modulus (psi) | 442,000 | 432,000 |
| Standard Deviation | 35,000 | 25,000 |

NOTCHED IZOD IMPACT @ Room Temperature (D638 Tensile Bar)

| | | |
|---|---|---|
| Impact (ft-lb/in) | 0.68 | 1.74 |
| Standard Deviation | 0.08 | 0.22 |
| Failure Mode | Brittle | Brittle |

Capillary Rheology @ 190° C.

| | | |
|---|---|---|
| 10.0 | 9589 | 12178 |
| 50.1 | 3801 | 4410 |
| 100.2 | 2633 | 2747 |
| 501.2 | 947 | 996 |
| 1002.3 | 569 | 597 |
| 2004.6 | 326 | 332 |
| 3006.9 | 230 | 233 |
| 4009.1 | 178 | 176 |
| 5011.4 | 143 | 145 |

Compared to controls (Examples 1, 2, 5, and 9), the halogenated polyolefin or core shell modifiers gave improved Izod impact resistance, while maintaining high stiffness and low melt viscosity. Examples 7 and 8 also indicated much improved Dynatup instrumented impact resistance.

1. A composition comprising, or produced from, polyvinyl chloride, filler, and an impact strength-retaining amount of a modifier wherein
the modifier is or includes a halogenated polyolefin, a core-shell resin, or combinations thereof;
the filler includes glass fiber, hollow glass microsphere, CaCO₃, silica, calcium silicate, calcium metasilicate, clay, mica, talc, alumina trihydrate, magnesium hydroxide, metal oxides, or combinations of two or more thereof; and
the halogenated polyolefin includes halogenated polyethylene, halogenated polypropylene, or combinations thereof.

2. The composition of claim 1 wherein the modifier is the halogenated polyolefin including polytetrafluoroethylene, fluoropolyethylene, chloropolyethylene, bromopolyethylene, fluoropolypropylene, chloropolypropylene, bromopolypropylene, or combinations of two or more thereof.

3. The composition of claim 2 wherein the filler is the glass fiber, calcium metasilicate, or combinations thereof.

4. The composition of claim 3 wherein the halogenated polyolefin is chloropolyethylene.

5. The composition of claim 4 wherein the filler is the calcium metasilicate.

6. The composition of claim 1 wherein the modifier is the core-shell polymer comprising one or more polymerized acrylic monomers including hydroxy alkyl(meth)acrylate or alkyl(meth), styrene, cycloalkyl(meth)acrylate, ethylenically unsaturated mono-carboxylic acids, silane-containing monomer, epoxy-containing monomer, or combinations of two or more thereof.

7. The composition of claim 6 wherein the filler is the glass fiber, calcium metasilicate, or combinations thereof.

8. The composition of claim 7 wherein the filler is the calcium metasilicate.

9. The composition of claim 8 wherein the core-shell polymer comprises one or more polymerized acrylic monomers.

10. The composition of claim 6 wherein the core-shell polymer further comprises a monomer including amine-containing monomer, (meth)acrylonitrile, or combinations thereof.

11. The composition of claim 1 further comprises an ethylene copolymer comprising repeat units derived from ethylene and alky (meth)acrylate, vinyl acetate, (meth)acrylic acid, or combinations of two or more thereof wherein the (meth)acrylic acid or a portion thereof is optionally 100% or less than 100% neutralized with a metal ion.

12. The composition of claim 11 wherein the ethylene copolymer further comprises repeat units derived from carbon monoxide, sulfur dioxide, acrylonitrile, maleic anhydride, dimethyl maleate, diethyl maleate, dibutyl maleate, dimethyl fumarate, diethyl fumarate, dibutyl fumarate, dimenthyl fumarate, maleic acid, maleic acid monoesters, itaconic acid, fumaric acid, fumaric acid monoester, a salt of the acids, glycidyl acrylate, glycidyl methacrylate, and glycidyl vinyl ether, or combinations of two or more thereof.

13. The composition of claim 12 wherein the ethylene copolymer includes ethylene butylacrylate copolymer, ethylene butylacrylate carbon monoxide copolymer, ethylene vinyl acetate copolymer, ethylene vinyl acetate carbon monoxide copolymer, or combinations of two or more thereof.

14. A process comprising combining PVC and filler with an impact strength-retaining amount of a modifier and wherein
the modifier is or includes a halogenated polyolefin, a core-shell resin, or combinations thereof;
the filler includes glass fiber, hollow glass microsphere, CaCO₃, silica, calcium silicate, calcium metasilicate, clay, mica, talc, alumina trihydrate, magnesium hydroxide, metal oxides, or combinations of two or more thereof;
the halogenated polyolefin includes halogenated polyethylene, halogenated polypropylene; and
the combining is carried out under a condition sufficient to prevent or minimize the reduction of impact strength of the blend, to reduce the molten viscosity of the blend, or to minimize the loss in stiffness (flexural modulus) of the blend, in comparison to a blend without the modifier.

15. The process of claim 14 wherein the filler is the glass fiber, calcium metasilicate, or combinations thereof.

16. The process of claim 15 wherein the modifier is the halogenated polyolefin.

17. The process of claim 15 wherein the modifier is the core-shell polymer.

18. The process of claim 15 wherein the process comprises combining the modifier and the filler to produce a sub-blend and combining the sub-blend with the PVC.

19. A article comprising or produced from a composition wherein the article includes decorative moldings inside or outside of a house, railroad ties, picture frames, furniture, porch decks, railings, window moldings, window components, door components, roofing systems, sidings, pellets, slugs, rods, ropes, sheets, or molded articles and the composition is as recited in claim 1.

20. The article of claim 19 wherein the composition comprises polyvinyl chloride, filler including glass fibers or calcium metasilicate, and a modifier including chloropolyethylene, acrylic core-shell polymer, or combinations thereof.
